(19) United States
(12) Patent Application Publication
(10) Pub. No.: US 2017/0097747 A1
(43) Pub. Date: Apr. 6, 2017

(54) SYSTEM FOR PREPARING A PATENT APPLICATION

(71) Applicant: Harold W. Milton, JR., Bloomfield Hills, MI (US)

(72) Inventors: Jacob Allen, Rochester Hills, MI (US); Harold W. Milton, JR., Bloomfield Hills, MI (US)

(21) Appl. No.: 15/380,241

(22) Filed: Dec. 15, 2016

Related U.S. Application Data
(63) Continuation-in-part of application No. 11/300,207, filed on Dec. 14, 2005, now abandoned.

(51) Int. Cl. G06F 3/0482; G06F 3/0481; G06F 3/0484; G06F 17/27; G06F 9/44; G06F 17/24; G06F 17/21

(52) U.S. Cl. CPC G06F 3/0482; G06F 17/243; G06F 3/04817; G06F 3/0481; G06F 17/211; G06F 17/2795; G06F 9/4446; G06F 3/0484

(57) ABSTRACT

A method of preparing a patent application by running a software macro to present a Tool bar (FIG. 1) to display options of Setup for document information and Number Claims for numbering the claims and Build Description for duplicating the claims into the description section and Build Intro Sections for dividing and duplicating selected claims into the introductory sections and Build Abstract and Count Abstract building and counting the words in the Abstract and Format for formatting and Mark Element for assigning a reference numeral to an element and Element List for listing the marked elements with reference numerals and Number Patent for automatically displaying the reference numerals with the each occurrence of the element name in the order of first recitation.

### CROSS REFERENCE TO RELATED APPLICATION

This Patent Application is a continuation-in-part of U.S. patent application Ser. No. 11/300,207, filed on Dec. 14, 2005.

### BACKGROUND OF THE INVENTION

1. Field of the Invention

A method of preparing a patent application in conjunction with a word processing program.

2. Description of the Prior Art

A method of preparing a patent application is disclosed in U.S. patent application Ser. No. 09/273,021, filed Mar. 19, 1999, which is now U.S. Pat. No. 7,890,851, in the name of one of the inventors herein. That method includes the steps of numbering and rearranging the order of claims and duplicating claims into the specification and assigning reference numerals to elements. This invention is in further perfection of the steps set forth in the aforementioned method.

### SUMMARY OF THE INVENTION AND ADVANTAGES

The invention provides a method of preparing a patent application characterized by running a software macro to display a Tool bar in a word processing program and presenting options in the Tool bar on a display screen of Setup and Number Claims and Build Description and Build Intro Sections and Build Abstract and Count Abstract and Format and Mark Element and Element List and Number Patent.

This invention provides efficiency in time and brings order to the preparation of a patent application. In a sense it automates much of the patent application preparation, but more importantly it brings consistency to the use of terms in the claims and description as well as the attendant numbering of elements in the description. The method automatically builds the patent application with the desired headings and the application title and identification. A claim tree or chart is provided to depict the dependency of the claims, along with the ability to change the order and/or claim dependency. The element names may be provided with synonyms to be numbered with like reference numerals and the elements are numbered in the description in the order of being first recited, along with the option of providing the reference numerals in the claims, as is required in some patent offices around the world. That portion of the broadest claim which precedes the characterized by clause is duplicated into the background section whereas that portion which is in the characterized by clause is duplicated into the summary of the invention. The invention drives the analysis toward isolating that which is novel from that which is prior art by the intermediate characterized by clause. The duplication of the claims into the description section assures that every claim finds antecedent support in the description, but in editing the duplicated claims, the order of presentation may be changed for easier reading and comprehension, with embellishments and alternative phraseology added. During the execution of the method, various alerts are provided for indicating errors and omissions.

The method is utilized as a tool for efficiency and quality in preparing a patent application and it is important that once the process is complete, the application may be edited to eliminate the “characterized by” clause in the claims, as it is merely used to force or to drive the practitioner to that which distinguishes the invention from the prior art. Once that isolation occurs, the method facilitates bringing together the rest of the sections of the application fitting and complementing one another in an efficient relationship.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a schematic view of a Tool bar utilized during the method of the subject invention;

FIG. 2 is a schematic view of an Application Settings option block for selecting options to preserve the document;

FIG. 3 is a schematic view of a Patent Setup data block for placing identifying information on the document;

FIG. 4 is a schematic view of Patent Headings data block with a plurality of heading data lines for providing headings in the patent application;

FIG. 5 is a schematic view of a Check Claims OK box indicating that the claims are OK;

FIG. 6 is a schematic view of a Claim Errors data box with the errors to the claims recited therein;

FIG. 7 is a schematic view of a Claim Numbering data block 20 presenting claim numbers displayed in a list;

FIG. 8 is a schematic view of a Claim Numbering data block presenting the claim numbers displayed in a dependency tree;

FIG. 9 is a schematic view of a Collect Claims decision box to affirm or reject the decision to collect and re-order the claim dependency;

FIG. 10 is a schematic view of a Change Claim Number data line for receiving a claim number to be renumbered;

FIG. 11 is a schematic view of a Change Parent Claim data line for receiving a substitute parent claim number for a highlighted claim;

FIG. 12 is a schematic view of an Insert Claims data block for receiving data for a new claim to be inserted into the claim tree;

FIG. 13 is a schematic view of a Format Document option block used to format the document;

FIG. 14 is a schematic view of a Select Claims data block 10 with the claims listed therein for selection for duplication into the description section;

FIG. 15 is a schematic view of a Build Text option indicating that text already exists in the description section;

FIG. 16 is a schematic view of an Add Element data block for numbering an element and adding the element to the element list;

FIG. 17 is a schematic view of an Element data block with element reference number and synonyms;

FIG. 18 is a schematic view of an Add Synonym data block for adding synonyms for elements;

FIG. 19 is a schematic view of a first Element Combinations data block;

FIG. 20 is a schematic view of a second Element Combination data block;

FIG. 21 is a schematic view of an Element List data block to present a list of the element names and the assigned reference numerals;

FIG. 22 is a schematic view of Number Patent option block presenting the headings of Detailed Description and Abstract and Claims for selecting options in each of those sections;

FIG. 23 is a schematic view of Element Report data block for showing elements recited in the description but not the claims;

FIG. 24 is a schematic view of a Protect Numbers data block to prevent numbers from being changed during the numbering of the elements recited therein;

FIG. 25 is a schematic view of an AutoProtect Numbers data block for selecting words with which numbers before or after will be protected against changer;

FIG. 26 is a schematic view of an AutoProtect data line for inserting a word so that all numbers before the word will be automatically protected;

FIG. 27 is a schematic view of an AutoProtect data line for inserting a word so that all numbers after the word will be automatically protected; and

FIG. 28 is a schematic view of Word Count data block for presenting the number of words in the Abstract;

### DETAILED DESCRIPTION OF THE INVENTION

Referring to the Figures, wherein like numerals indicate corresponding parts throughout the several views, a method of preparing a patent application is illustrated by showing the various steps in the form of computer screen displays for numbering and rearranging the order of claims and duplicating claims into the specification and assigning reference numerals to elements. The titles and nomenclature presented in the various steps are italicized herein for convenience.

The method utilizes a computer system operating a word processing software having a software macro. The computer system includes input hardware, e.g., a mouse, touch screen, or a keyboard, output hardware, e.g., a monitor or computer screen, storage hardware and processing hardware. The storage hardware stores the word processing software of the computer system. The processing hardware facilitates communication between the input device, the storage hardware and the output device for displaying a word document on the output device. The input hardware allows a user to input data into the computer system where the data is stored by the storage hardware. The input hardware also allows a user to select data displayed in the word document on the display device. Once data is received from the input hardware or once a user selects data displayed in the word document, the processing hardware processes the data and communicates between the word processing software and the storage hardware and the output hardware to display the data in the word document of the output hardware.

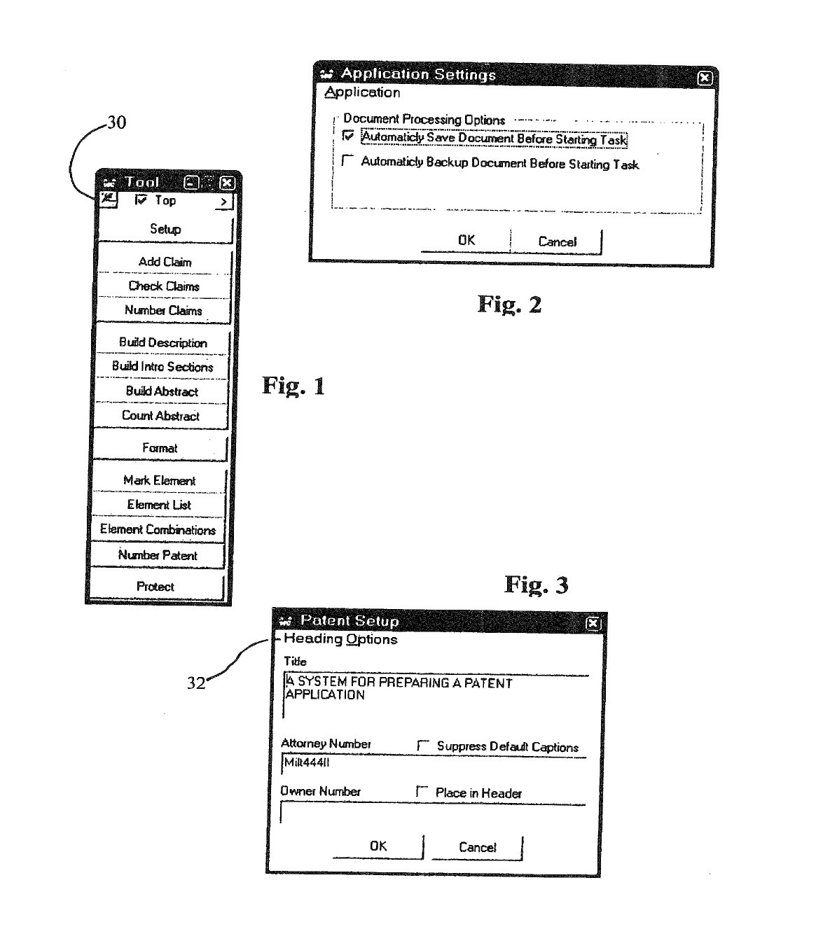

The first instance of the method is performed in conjunction with the word processing software and the processing hardware by running the software macro to present a Tool bar in the word document. This Tool bar is illustrated in FIG. 1 and would normally appear on one side of the computer screen in the word document. The method begins by presenting options in the Tool bar on the computer screen of Application Settings and Setup and Add Claim and Check Claims and Number Claims and Build Detailed Description and Build Intro Sections and Build Abstract and Count Abstract and Format and Mark Element and Element List and Element Combinations and Number Patent and Protect. The Application Settings option is presented by an Application Settings icon 30. Selecting the Application Settings icon 30 (as by a double click with a mouse) displays an Application Settings option block as shown in FIG. 2 to present the Document Processing Options of selecting Automatic Save Document and Automatic Backup Document in the word document prior to starting the task of preparing a patent application. Either of these Document Processing Options may be selected by merely clicking on the check box associated with each of Automatic Save Document and Automatic Backup Document. The options are self-explanatory in that by selecting the options the document is automatically saved and /or backed up.

After clicking on OK in the Application Settings option block, the method may proceed by selecting the Setup option in the Tool bar to display a Patent Setup data block, as illustrated in FIG. 3, in the word document. A Title data line is presented in the Patent Setup data block for inserting the title of the invention to appear in the word document at the beginning of the word document and optionally on the Abstract page, as will become clearer hereinafter. An Owner Number file number data line is presented in the Patent Setup data block for inserting a file number used by the patent owner to be displayed in the footer of the word document as a default but which can be placed in the header by checking the Place in Header option. An Attorney Number file number data line is presented in the Patent Setup data block for inserting a docket number for the file used by the patent preparer, i.e., an Attorney or Patent Agent, into the footer of the word document. The Attorney Number for the file is placed in the footer for easy access and viewing when the top of the pages are secured in a file wrapper. A Suppress Default Captions option is presented for deleting the default captions of Owner Number and Attorney Number with the respective file numbers in the footer and header of the word document. In other words, in the default mode, the captions of Owner Number and Attorney Number would precede the respective file numbers in the document, but would not if the Suppress Default Captions option is checked.

The invention proceeds by displaying a Heading Options 32 in the Patent Setup data block for selecting Heading Options in the Patent Setup data block to present a Patent Headings data block as shown in FIG. 4 with a plurality of heading data lines. A name is displayed adjacent each heading data line including Related and Background and Field and Prior Art and Summary and Drawings and Description and Claims and Abstract and Classification and Element List. A default heading is presented in each heading data line but may be edited, i.e., the default heading in the respective heading data line may be edited and changed for insertion into the word document. The default headings may be the headings suggested by the United States Patent and Trademark Office (USPTO), or by any other patent office around the world. A Defaults option is presented in the Patent Headings data block for returning to the default headings in all of the heading data lines.

Once each of the data lines of the Patent Headings data block is filled out, the Save data block of the Patent Headings data block is clicked and the user is returned to the Patent Settings data block. The user can then selects the OK data bock of the Patent Setup data block where the computer processing software will insert each of the patent headings, title, attorney number, and owner number into the word document to build the patent application.

Another step resides in the selecting of the Add Claim data block in the Tool bar to add a claim to the word document. The user then drafts a first claim in the word document to continue building the patent application. Yet another step resides in the selecting of the Add Claim data block in the Tool bar to add the next numbered claim with the preamble of the previous claim into the word document to build the patent application.

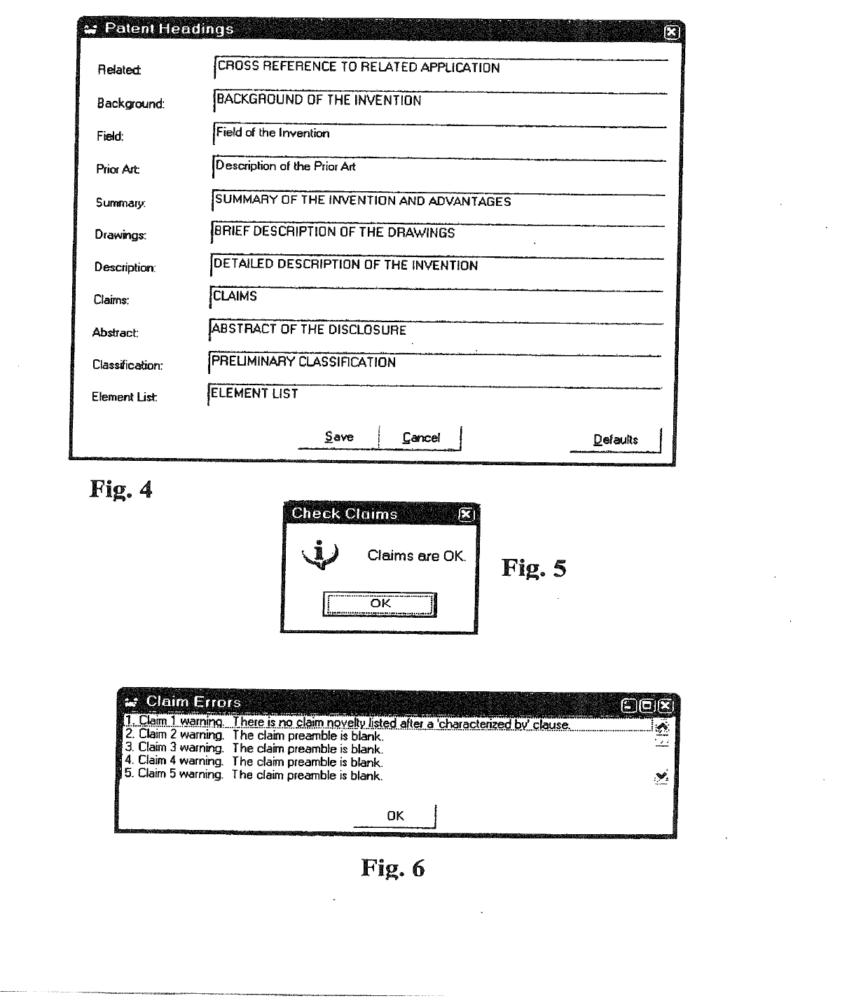

Another step resides in the selecting of Check Claims in the Tool bar. Once selected the word processing program scans the word document to check the claims for a “characterized by” clause. If the claims are in order, i.e. have no errors, a Check Claims OK box will appear as shown in FIG. 5 indicating that the claims are OK, and user selects the OK data block of the Check Claims data block. If the claims are not OK, a Claim Errors data box as shown in FIG. 6 will appear on the screen with the errors to the claims recited therein. The main errors that are alerted are the absence of a preamble and/or the omission of a “characterized by” clause in an independent claim. The user can then edit the claims to avoid the errors identified in the Claim Errors data block.

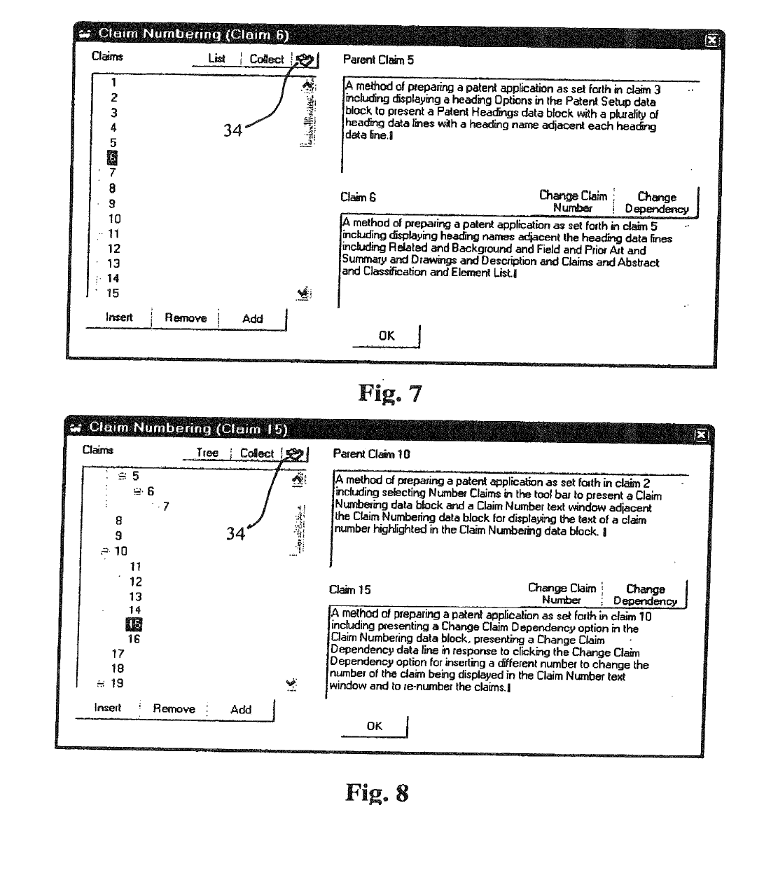

Another step includes selecting Number Claims in the Tool bar to present a Claim Numbering data block in the word document with the claim numbers therein and presenting adjacent the Claim Numbering data block the options of List and/or Tree for displaying the claim numbers in the Claim Numbering data block in a list or in a claim dependency tree schematically or graphically showing the dependency of the claims. By selecting the List option, the claim numbers are displayed in a list in the Claim Numbering data block, as shown in FIG. 7. By selecting the Tree option, the claim numbers are displayed in a dependency tree in the Claim Numbering data block as shown in FIG. 8. A copy to clipboard option icon 34 is presented adjacent the Claim Numbering data block for copying the claim dependency tree to the clipboard, from which the presentation may be printed.

A Collect option is presented adjacent the Claim Numbering data block for arranging the order of and renumbering the claims to place each claim as close as possible to the parent claim from which it depends. As a double check, since this is such a significant reorganization of the claims, a Collect Claims decision box will appear as shown in FIG. 9 to affirm or reject the decision to collect and re-order the claims.

As shown in FIG. 7, a Claim Number text window is presented adjacent the Claim Numbering data block in the word document for displaying the text of a claim number highlighted in the Claim Numbering data block from the list of claims presented therein. When the Claim Numbering data block is first displayed, there is no text in the Claim Number text window, but when a claim is highlighted the claim number is presented next to the text window and the text of that highlighted claim is shown in the lower text window along with the text of the parent claim in the upper text window, with the parent claim number adjacent the upper text window, as shown in FIG. 7. Likewise, when a claim is highlighted by clicking on the claim number when presented in a claim tree, the text of the highlighted claim appears in the lower Claim Number text window and the name of the Claim Number text window is changed to Claim followed by the number of the claim number highlighted in the Claim Numbering data block, as shown in FIG. 8. In a similar fashion, when in the claim tree mode, the Parent Claim text window is presented adjacent the Claim Numbering data block for displaying the text of the parent claim to the claim number highlighted in the Claim Numbering data block, as shown in FIG. 8. Again, when the Claim Numbering data block is first displayed, there is no text in the Parent Claim text window. However, when the claim is highlighted, the text of the parent claim to the highlighted claim appears in the Parent Claim text window and the name of the Parent Claim text window is changed to add to the Parent Claim the number of the claim from which the claim number highlighted in the Claim Numbering data block depends, as shown in FIG. 8. Although not shown, the text of an independent claim highlighted is displayed in the Claim Number text window and the Claim Numbering data block is renamed with the claim number highlighted.

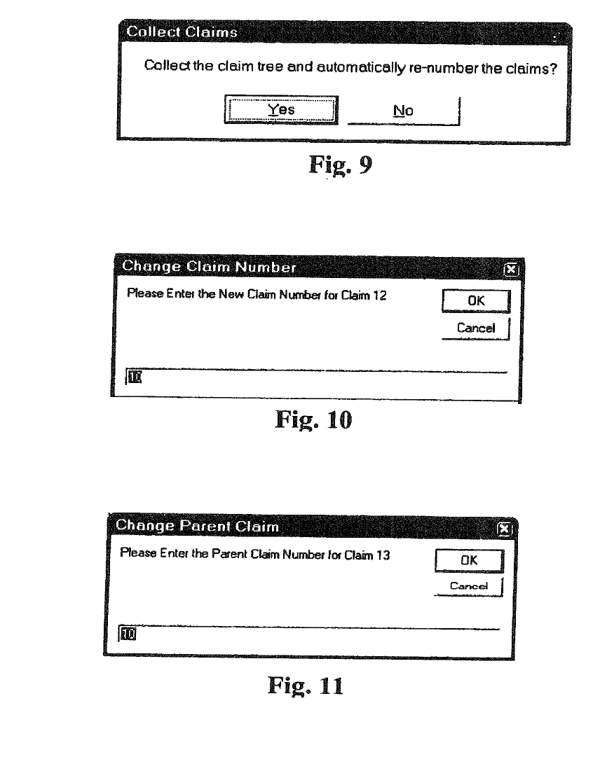

As shown in FIGS. 7 and 8, a Change Claim Number option is presented in the Claim Numbering data block. A Change Claim Number data line, as shown in FIG. 10, is displayed in response to clicking the Change Claim Number option for inserting a different claim number to re-number the claim being displayed and highlighted in the Claim Number window. Accordingly, all of the claims are renumbered by the word processing program to accommodate the change in the claim number displayed in the Claim Number text window in response to clicking the OK in the Change Claim Number data line.

Also as shown in FIGS. 7 and 8, a Change Dependency option is presented in the Claim Numbering data block. A Change Parent Claim data line, as shown in FIG. 11, is displayed in response to clicking the Change Dependency option for inserting by the user a different number of the parent claim to the claim being displayed and highlighted in the Claim Number text window. Accordingly, all of the claims are renumbered by the word processing program to accommodate the change in the dependency of the claim displayed and highlighted in the Claim Numbering data block in response to clicking the OK in the Change Parent Claim data line.

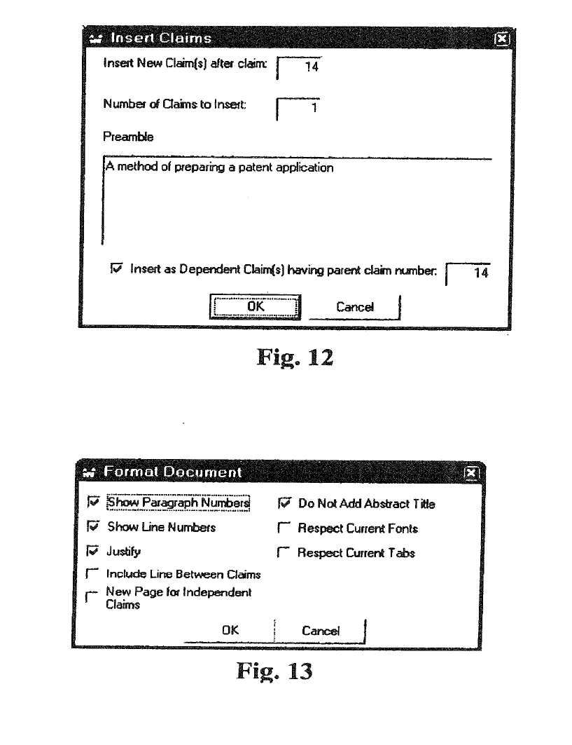

An Insert option is displayed adjacent the Claim Numbering data block for inserting a claim dependent upon a claim number highlighted in the Claim Numbering data block. As a safeguard, the display of an Insert Claims data block is prevented unless a claim number is highlighted in the Claim Numbering data block. The Insert Claims data block shown in FIG. 12 is displayed in response to clicking the Insert option. A Number of Claims to Insert data line is presented in the Insert Claims data block for inserting the number of claims to be inserted. An Insert New Claim(s) after Claim data line is presented in the Insert Claims data block for inserting the number of the claim preceding the first claim to be inserted into the word document. A Preamble data block is presented in the Insert Claims data block for displaying and editing the preamble of the first claim to be inserted into the word document.

Back to the Claim Numbering data block, a Remove option is presented for removing a claim, i.e., by selecting the Remove option, a highlighted claim is removed or deleted from the word document by the word processing program. In addition, an Add option is presented adjacent the Claim Numbering data block for adding a claim to the word document by selecting the Add option.

By selecting Format in the Tool bar, a Format Document option block is displayed in the word document, as shown in FIG. 13. The Format Document option block presents a plurality of options including: a Show Paragraph Numbers option for showing the successive numbers of successive paragraphs in brackets at the beginning of each paragraph in the application; a Show Line Numbers option for showing at least some of the line numbers on each page of the application, e.g., every fifth line; a Justify option for justifying the text on each page of the application; an Include Line Between Claims option for providing an extra line between claims; a New Page For Independent Claims option for starting each independent claim at the top of a new page in the application; a Do Not Add Abstract Title option to select the option of omitting the title on the Abstract page; a Respect Current Fonts option to select the option of preserving changes to default fonts; and a Respect Current Tabs option to select the option of preserving changes to default tabs. Each of these options may be individually selected by clicking on the block next to each title to place a check in the block to activate the option, which options will be implemented by the word processing software upon clicking OK, as is the case for all other options presented in the method.

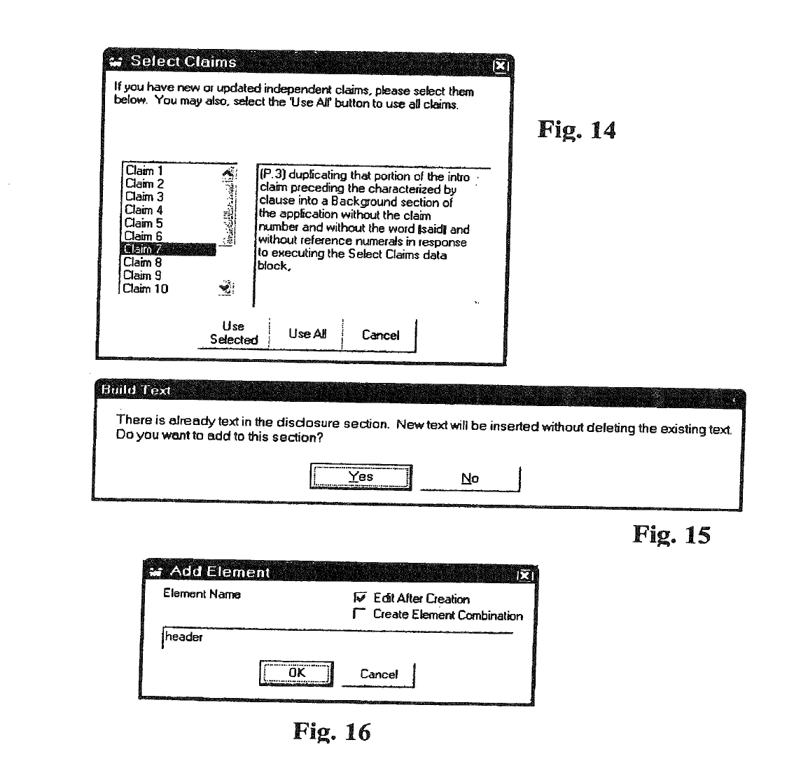

By selecting Build Description in the Tool bar, a Select Claims data block is presented with the claims listed therein, as shown in FIG. 14. However, in the event there are errors in the claims, a Claims Error data block like that shown in FIG. 6 will first be displayed. Additionally, in the event there is already text in the description section, a Build Text option, as illustrated in FIG. 15, will first be displayed in response to selecting Build Description and that text already exists in the description section and the YES and NO options to add or not add the new text in addition to the existing text. Without these preliminary indicators, or after they are cleared, the Select Claims data block is presented with the claims listed therein. More specifically, a claim numbers data line with the claim numbers therein is displayed in the Select Claims data block along with a claim text data line for presenting the text of highlighted claims therein. By highlighting at least one claim number in the claim numbers data line, the text of the highlighted claim in the claim numbers data line is presented in the claim text data line, as is illustrated in FIG. 14.

A Use Selected option is presented in the Select Claims data block for duplicating by the word processing program the highlighted claims in the claim numbers data line into a description section of the application without claim numbers and without the word “said” and having paragraph numbers in brackets. In other words, when one or more claims are highlighted in the claim numbers data line, the text of those claims appears in the claim text data line and is duplicated by the word processing program into the description section in response to selecting the Use Selected option, but without claim numbers and without the word “said.”

A Use All option is also presented in the Select Claims data block, for duplicating by the word processing program all of the claims (highlighted or not) into a description section of the application without claim numbers and without the word “said” and having paragraph numbers in brackets. In other words, the text of all of the claims in the claim numbers data line is duplicated by the word processing program into the description section in response to selecting the Use All option, but without claim numbers and the word “said.”

After the selected claims are duplicated into the description section, the Format Now block is again displayed with the YES and NO options for formatting the word document. The entire word document will be formatted by the word processing software in response to selecting the YES option.

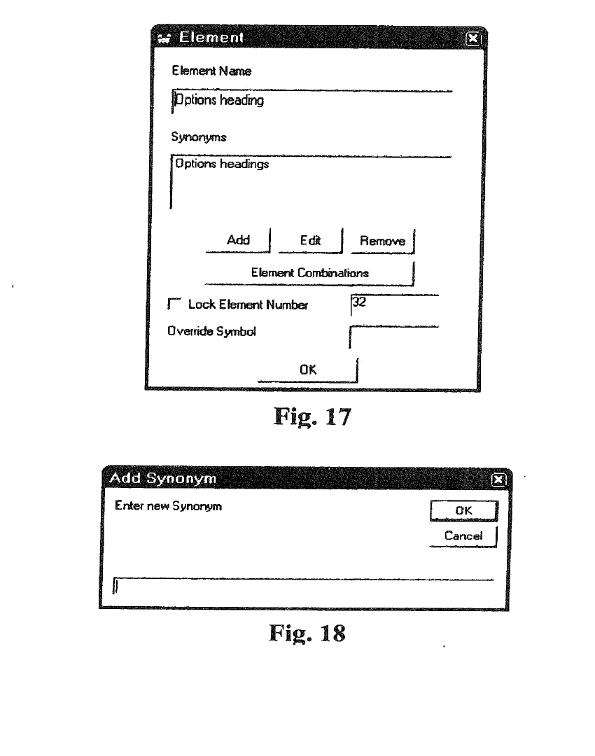

As the description section is edited by the user by placing the claims in proper grammar and rearranging the order of the substance of the claims for an effective and orderly presentation, which are matters of preference for the individual users of the method, an element name may be highlighted as it appears in the description section. Once an element is highlighted, the Mark Element may be selected in the Tool bar to display an Add Element data block with the high-lighted element name presented, as illustrated in FIG. 16. The Add Element data block presents the options of Edit After Creation and Create Element Combination. By selecting the Edit After Creation, an Element data block (FIG. 17) is displayed to present the element name and synonyms of the element name and an Add option for adding synonyms and an Edit option for editing synonyms and a Remove option for removing a synonym and a Lock Element Numeral option to lock the reference numeral (or other symbol) to be assigned to the element name to prevent that assigned reference numeral from being changed and an Override Symbol data line for inserting a special reference symbol for the element name and an Element Combinations option. Selecting the Add option displays an Add Synonym data block for entering additional synonyms for the displayed element name and reference numeral, as illustrated in FIG. 18. Adding the text of the synonym in the data line of Add Synonym data block will cause each occurrence of that synonym to be numbered with the same reference numeral assigned to the element name initially marked. Selecting the Edit option displays an Edit Synonym data block, just like that shown in FIG. 18 but labeled Edit Synonym for editing the synonyms for the displayed element name. The method therefore proceeds by assigning the reference numerals assigned to the element name to all occurrences of that element name and all synonyms added and edited.

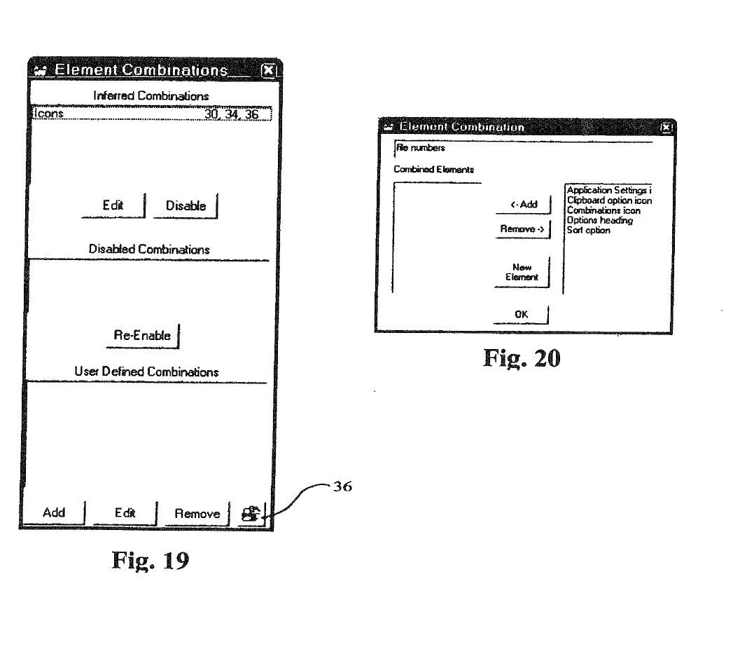

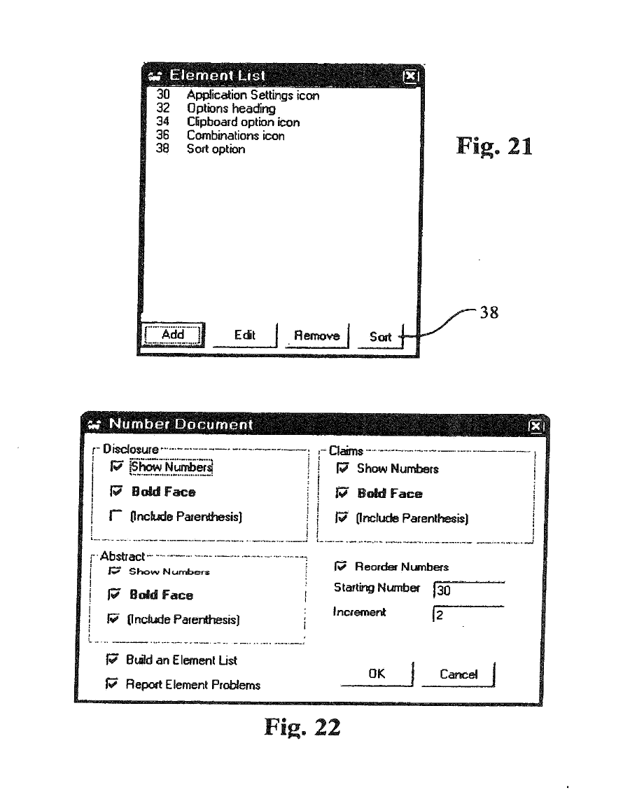

By selecting Element Combinations in the Tool bar, a first Element Combinations data block is displayed, as illustrated in FIG. 19. The first Element Combinations data block presents an Inferred Combinations data line to display a selected element name in the plural without an adjective and all reference numerals used with that selected element name, whether or not differentiated by adjectives, i.e., the root element name. The first Element Combinations data block also presents a Disabled Combinations option to disable the assignment of any reference numerals to the selected element name in the Inferred Combinations data line so that no reference numeral is assigned to the selected element name when used alone without an adjective and presenting the option to re-enable the assignment of any reference numerals to the selected element name. The first Element Combinations data block further presents a User Defined Combinations data line to add the selected element name and a new adjective to be numbered with the reference numerals of certain adjectives used with the selected element name, i.e., the User Defined Combinations data line allows selected combinations to be jointly numbered. In addition, a combinations icon 36 for changing the order of the reference numerals and the element names in the data lines in the first Element Combinations data block. By clicking on the combinations icon 36 the reference numerals alternately appear first in each data line in the first Element Combinations data block, or the element name appears first as illustrated in FIG. 19.

By selecting Element Combinations in any of the Element data blocks, a second Element Combination data block as illustrated in FIG. 20 is displayed and presents a data line for entering a new element for adding an element to be combined with or use the same reference numeral as the numbered element selected, which will then appear under User Defined Combinations as shown in FIG. 19. By clicking on an element name and on Add, the new element typed in the above data line will then be assigned the same reference numeral.

At any time during or as many times as desired in the editing of the description. Number Patent may be selected in the Tool bar. So long as each root element name and its identifying adjective are highlighted together as one element and Mark Element is selected, a different reference numeral will be assigned and displayed in the text by the word processing software with each such root element name distinguished by its different adjective. In other words, a different reference numeral will be assigned to describe different elements in response to high-lighting each root element name plus the different adjective for each different adjectively distinguished element in response to selecting Number Patent in the Tool bar. Each element name highlighted in combination with a different adjective will receive a different reference numeral. Also in response to selecting Number Patent in the Tool bar, all of the different reference numerals assigned to the root element name differentiated by different adjectives will be assigned and displayed in the text in each instance of the root element name being used without a differentiating adjective. Said another way, each occurrence of a root element name appearing in the text will be assigned all of the reference numerals assigned to that root element name with or regardless of the distinguishing adjectives, or in the User Defined Combinations. The most basic response to selecting Number Patent in the Tool bar is the displaying in the word document the reference numerals assigned to each element name to all occurrences of that element name and all synonyms added and edited.

By selecting Element List in the Tool bar, an Element List data block is displayed and presents a list of the element names and the assigned reference numerals along with options to Add and Remove and Edit. A Sort option 38 allows the presented element names to alternately appear alphabetically or in order of reference numeral by successively clicking on the Sort option 38. As illustrated, the element names appear in the numerical order of the reference numerals but by clicking on the Sort option 38, the element names would appear to the left and in alphabetical order followed by the respective reference numerals. Accordingly, successively selecting the Sort option 38 on the Element List data block sorts the element names on the list alternately in order of reference numeral or alphabetically by element name.

The selection of the Add option on the Element List data block presents the Add Element data block, which is shown in FIG. 16, for adding an element. The Element data block of FIG. 17 is displayed in response to adding an element in the Add Element data block and in response to highlighting an element name in the Element List and selecting the Edit option on the Element List data block. By highlighting an element name in-the Element List and selecting the Remove option on the Element List data block, the highlighted element name is removed by the word processing program from the Element List, thereby freeing its assigned reference numeral for re-use.

In response to selecting the Number Patent option in the Tool bar, a Number Patent option block, as illustrated in FIG. 22, is displayed and presents the headings of Disclosure and Abstract and Claims.

A Show Numbers option is presented under each of the headings of Description and Abstract and Claims on the Number Patent option block for selecting to show reference numerals in each section. By selecting the Show Numbers option under the Description heading, the element numerals will be inserted into the word document by the word processing program with each occurrence of the element name in the Detailed Description section of the application. By selecting the Show Numbers option under the Abstract heading, the element numerals will be inserted into the word document by the word processing program with each occurrence of the element name in the Abstract section of the application. By selecting the Show Numbers option under the Claims heading, the element numerals will be inserted into the word document by the word processing program with each occurrence of the element name in the Claims section of the application.

A Bold Face option is presented under each of the headings of Disclosure and Abstract and Claims on the Number Patent option block for selecting to show bold reference numerals in each of these sections in the word document. By selecting the Bold Face option under the Disclosure heading, the element numerals in a bold font will be inserted into the word document by the word processing program with each occurrence of the element name in the description section of the application. By selecting the Bold Face option under the Abstract heading, the element numerals in a bold font will be inserted in the word document by the word processing program with each occurrence of the element name in the Abstract section of the application. By selecting the Bold Face option under the Claims heading, the element numerals in a bold font will be inserted in to the word document by the word processing program with each occurrence of the element name in the Claims section of the application.

An Include Parenthesis option is presented under each of the headings of Disclosure and Abstract and Claims on the Number Patent option block for selecting to show reference numerals in parenthesis in these sections of the word document. By selecting the Include Parenthesis option under the Disclosure heading, the element numerals between parentheses will be inserted into the word document by the word processing program in each occurrence of the element name in the Detailed Description section of the application. By selecting the Include Parenthesis option under the Abstract heading, the element numerals between parentheses will be inserted into the word document by the word processing program in each occurrence of the element name in the Abstract section of the word document. By selecting the Include Parenthesis option under the Claims heading, the element numerals between parentheses will be inserted into the word document by the word processing program in each occurrence of the element name in the Claims section of the application.

The Number Patent option block also presents a Build Element List option for electing to generate an element list, i.e., the element list is generated by the word processing program in response to selecting or clicking on the Build Element List option. The Number Patent option block further presents a Report Element Problems option for electing to generate by the word processing program an Element Report data block as illustrated in FIG. 23 in response to inconsistencies in the element list. The Element Report data block will indicate that there are no problems or that there are problems, e.g., that an element recited in the description section is not recited in the claims, as would be illustrated in FIG. 23.

A Reorder Numbers option is presented on the Number Patent option block for electing to assign reference numerals to elements in the order of being first recited in the description section of the application so that the elements are numbered in order of first recitation in the description section of the application each time Number Patent is selected in the Tool bar. By selecting the Reorder Numbers option, the word processing program will re-assignee the reference numerals with the insertion or interleaving of an element in the description section so that the reference numerals are introduced in order of the element being first recited in the description.

A Starting Number data line is presented on the Number Patent option block for selecting the lowest reference numeral to be used in numbering the elements in the application and presenting a default starting reference numeral. The default reference numeral is twenty, the purpose of which is to keep the starting reference numeral higher than the highest Figure number. In the case of this document, the number of Figures did not exceed thirty, so to avoid overlapping numbers being used for both Figure numbers and reference numerals, the reference numeral thirty was been inserted into the Starting Number data line, as illustrated in FIG. 22. In other words, the default reference numeral of twenty in the Starting Number data line on the Number Patent option block was replaced with the lowest reference numeral thirty to be used in numbering the elements in the application. It is preferable to start the reference numerals at the next numeral ending in a zero, e.g., twenty, thirty, forty, etc.

An Increment data line is presented on the Number Patent option block for selecting the number of numerals to be omitted between reference numerals to be used in numbering the elements in the application. By inserting the number of numerals to be omitted between reference numerals in the Increment data line, the reference numerals with element names and synonyms will be assigned by the word processing program in the order of being first recited in the description section of the application and starting with the lowest reference numeral in the Starting Number data line but separated by the number of numerals to be omitted in the Increment data line. The default integer in the Increment data line is two as illustrated, but could be one or any other separating number. It has been traditional to separate the reference numerals by an integer of two so that elements could be inserted or interleaved in the description and given an odd numeral between the element reference numerals first recited before and after the new element. Even though the instant method facilitates the use of consecutive reference numerals, it remains good practice to use only odd or even reference numerals in the preparation so that an intermediate or interleaving reference numeral could be added after the application has filed in a patent office and the reference numerals cannot be rearranged, i.e., re-assigned to element names.

An OK option is presented on the Number Patent option block. Accordingly, the reference numerals are displayed in the word document with element names and synonyms in the text of the application in response to selecting the Number Patent option in the Tool bar and/or selecting OK in anyone of the Number Patent option block and the Add Element and Edit After Creation and Create Element Combination data blocks.

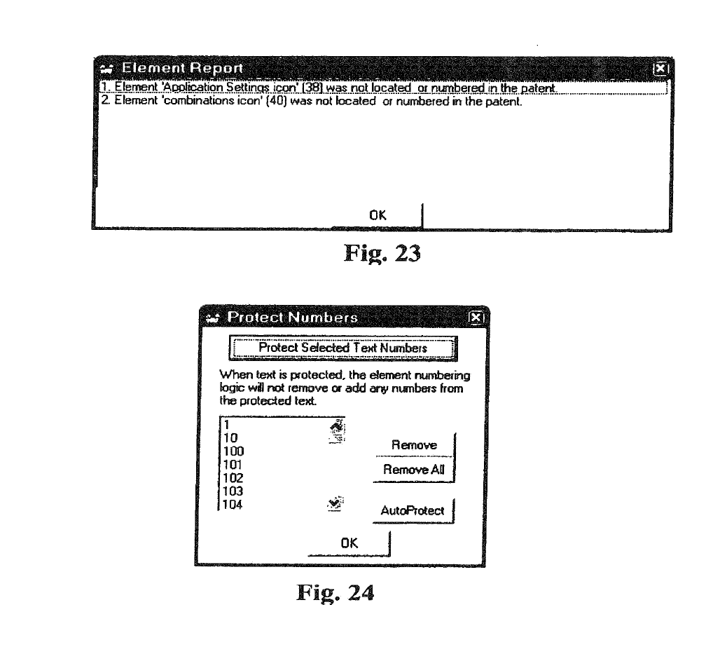

By selecting Protect in the Tool bar, a Protect Numbers data block is displayed for presenting a Protect Selected Text Numbers option and an Auto-Protect option, as illustrated in FIG. 24. Before selecting Protect in the Tool bar, a word and/or associated number (not a reference numeral) is highlighted in the text to be protected against change. When the Protect Numbers data block appears, the Protect Selected Text Numbers option is then selected to add the numbers to be protected and assigning a sequential digit in the Protect Numbers data block. For example, if a ratio of 5 to 2 is recited in the text, the “ratio of 5 to 2” would be highlighted and the Protect Selected Text Numbers option clicked upon to prevent “ratio of 5 to 2” from being changed during any numbering step. The same could be applied to the subparagraph numbers used in distinguishing subparagraphs of the claims.

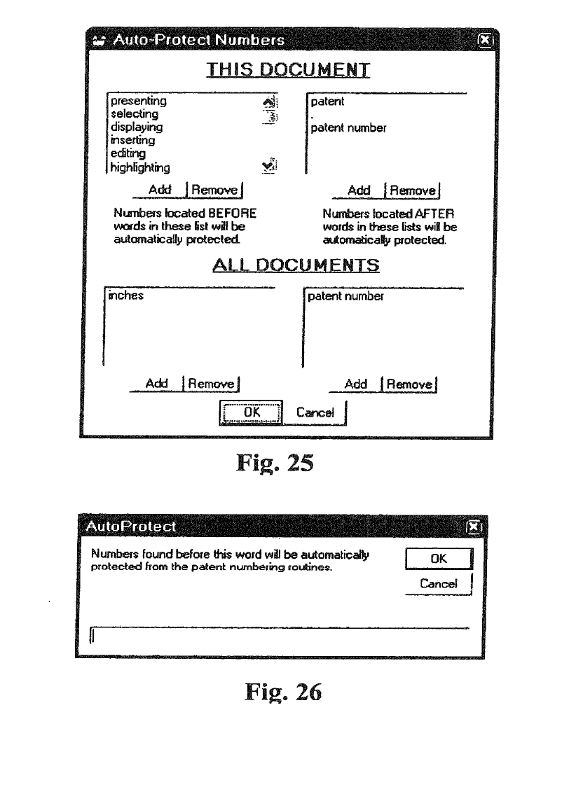

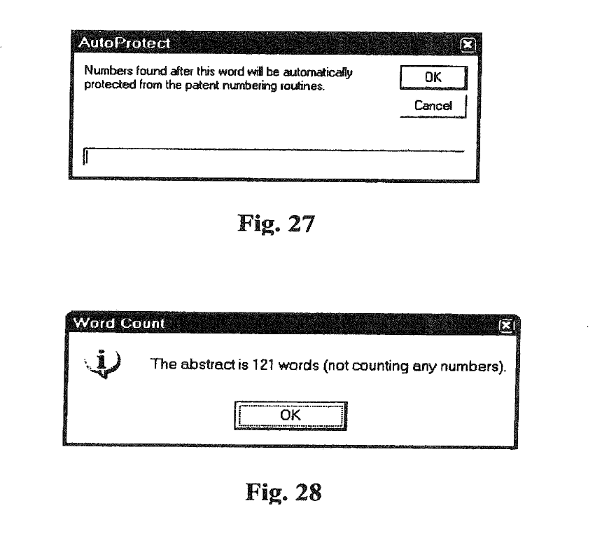

By selecting the Auto-Protect option, an AutoProtect Numbers data block is displayed (FIG. 25) to present a This Document heading and an All Documents heading with a before data line and an after data line associated with each heading and presenting an Add option and a Remove option adjacent each before and after data line and an OK option. An AutoProtect data line (FIG. 26) is presented for inserting a word so that all numbers before the word will be automatically protected from change during patent numbering routines in response to clicking the Add option associated with either of the before data lines of either of the Document headings, i.e., inserting a word in the AutoProtect data line will protect numbers before every occurrence the word. Similarly, an AutoProtect data line (FIG. 27) is presented for inserting a word so that all numbers after the word will be automatically protected from change during patent numbering routines in response to clicking the Add option associated with either of the after data lines of either of the Document headings, i.e., inserting a word in the AutoProtect data line will protect all numbers after every occurrence of the word. Accordingly, all numbers before and after the words inserted in anyone of the AutoProtect data lines are protected against change during patent numbering routines in response to selecting the OK option presented by the AutoProtect Numbers data block. However, word may be removed from a data line in response to highlighting the word and clicking on the Remove option associated with anyone of the data lines of the Document headings in the AutoProtect Numbers data block. The data lines in the AutoProtect Numbers data block under all documents can be used to insert words having numbers associated therewith in any document with which the method issued that will always be protected. For example, the patent numbers associated with the word patent or patent number would always be protected. Other words frequently having numbers associated therewith are inches and degrees.

By selecting the Build Intro Sections option in the Tool bar, the Select Claims data block is displayed to present a claim to be used as an intro claim in building the introductory sections of the application. In response to executing the Select Claims data block, the characterized by portion of the intro claim is duplicated by the word processing program into a Summary of Invention section of the word document without a claim number and without the word “said” and without reference numerals. At the same or in the same step, that portion of the intro claim preceding the characterized by clause is duplicated by the word processing program into a Background section of the word document without the claim number and without the word “said” and without reference numerals. Further in the same step, the preamble of the intro claim is duplicated by the word processing program into a Technical Field section of the word document without a claim number and without the word “said” and without reference numerals. In other words, the claim selected for the intro sections is divided and placed in the respective appropriate headings in the introductory section of the word document by the word processing program to build the patent application. In addition, a default cross reference heading to another application is displayed in the word document as the first heading in the word document in response to executing the Select Claims data block, which will be filled in with serial number and filing date of the related application or will be deleted in the editing as the introductory sections of the application are edited. If there is already text in any of the sections, under any of the headings, a Build Text option like that illustrated in FIG. 15 will be displayed.

In a similar fashion, an Abstract page is displayed in response to selecting the Build Abstract option in the Tool bar. The suggested heading for the Abstract page is “ABSTRACT OF THE DISCLOSURE” as the Abstract should not be in claim language or merely a recitation of the broad claim but should convey to one familiar with the art an understanding or an insight into that which is novel in the disclosure. The Abstract page can be filled in by selecting sentences from the description section. And, as alluded to above, the reference numerals may or may not be included depending upon the selection made in the Number Patent option block of FIG. 22. By selecting the Count Abstract option in the Tool bar, the number of words in the Abstract are counted by the word processing program and the number of words absent reference numerals in the Abstract section are presented in a Word Count data block as illustrated in FIG. 28.

The paragraph numbers in brackets are automatically changed by the word processing program or kept in order in response to adding a paragraph to the application.

Obviously, many modifications and variations of the present invention are possible in light of the above teachings. It is to be understood that the headings and nomenclature used herein is used in an equivalent manner to set forth a step and is meant to cover equivalents of the action performed in the step. For example. Number Patent should be interpreted to cover the active step of assigning reference numerals to the elements marked to be numbered in the document in the sections selected. Accordingly, the invention may be practiced otherwise than as the specific words so long as it is within the scope and equivalency of the appended claims, wherein that which is prior art is antecedent to the novelty set forth in the “characterized by” clause. The novelty is meant to be particularly and distinctly recited in the “characterized by” clause whereas the antecedent recitations merely set forth the old and well-known combination in which the invention resides. These antecedent recitations should be interpreted to cover any combination in which the incentive novelty exercises its utility. In addition, the reference numerals in the claims are merely for convenience and are not to be read in any way as limiting.

What is claimed is:

1. A method of preparing a patent application comprising the steps of;
numbering and rearranging the order of claims and duplicating claims into the specification and assigning reference numerals to elements,
running a software macro to present a Tool bar in a word processing program,
presenting options in the Tool bar on a display screen of Application Settings and Setup and Add Claim and Check Claims and Number Claims and Build Description and Build Intro Sections and Build Abstract and Count Abstract and Format and Mark Element and Element List and Element Combinations and Number Patent and Protect,
(A) selecting Application Settings to present the options of selecting Automatic Save Document and Automatic Backup Document prior to starting task,
(B) selecting the Setup option in the Tool bar to display a Patent Setup data block,
(B.1) presenting a Title data line in the Patent Setup data block,
(B.2) inserting the title of the invention in the Title data line of the Patent Setup data block,
(B.3) presenting an Owner Number file number data line in the Patent Setup data block,
(B.4) inserting a file number used by the patent owner in Owner Number file number data line of the Patent Setup data block,
(B.5) presenting an Attorney Number file number data line in the Patent Setup data block,
(B.6) inserting a file number used by the patent preparer in Attorney Number file number data line of the Patent Setup data block,
(B.7) presenting a Place in Header option for placing the Owner Number file number in the header or the footer line in the Patent Setup data block,
(B.8) presenting a Suppress Default Captions option in the Patent Setup data block for deleting the default captions of Owner Number and Attorney Number with the respective file numbers in the footer and header of the document,
(B.9) displaying an Heading Options (32) in the Patent Setup data block,
(B.9.1) selecting the Heading Options (32) in the Patent Setup data block to present a Patent Headings data block with a plurality of heading data lines,
(B.9.2) displaying a name adjacent each heading data line including
Related and Background and Field and Prior Art and Summary and Drawings and Description and Claims and Abstract and Classification and Element List,
(B.9.3) displaying a default heading in each heading data line,
(B.9.4) editing the default heading in the respective heading data lines for insertion into the application,
(C) selecting Add Claim in the Tool bar to add the next numbered claim with the preamble of the previous claim,
(D) selecting Check Claims in the Tool bar to check the claims for a characterized by clause,
(E) selecting Number Claims in the Tool bar to present a Claim Numbering data block with the claim numbers therein,
(E.1) presenting adjacent the Claim Numbering data block the options of List and Tree for displaying the claim numbers in the Claim Numbering data block in a list or in a claim dependency tree schematically showing the dependency of the claims,
(E.2) selecting the List option to display the claim numbers in a list in the Claim Numbering data block,
(E.3) selecting the Tree option to display the claim numbers in a dependency tree in the Claim Numbering data block,
(E.4) presenting a Collect option adjacent the Claim Numbering data block for arranging the order of and renumbering the claims to place each claim as close as possible to the parent claim from which it depends,
(E.5) selecting the Collect option to arrange the order of and renumbering the claims to place each claim as close as possible to the parent claim,
(E.6) presenting a copy to clipboard option icon adjacent the Claim Numbering data block for copying the claim dependency tree and the claim list to the clipboard,
(E.7) selecting the copy to clipboard option icon adjacent the Claim Numbering data block to copy the claim dependency tree and the claim list to the clipboard,
(E.8) presenting a Claim Number text window adjacent the Claim Numbering data block for displaying only the text of a claim number highlighted in the Claim Numbering data block,
(E.9) highlighting a claim number in the Claim Numbering data block to present the text of the highlighted claim in the Claim Number text window and changing the name of the Claim Number text window to Claim followed by the number of the claim number highlighted in the Claim Numbering data block,
(E.10) presenting a Parent Claim text window adj acent the Claim Numbering data block,
(E.11) displaying the text of the parent claim to the claim number highlighted in the Claim Numbering data block in the Parent Claim text window and changing the name of the Parent Claim text window to Parent Claim followed by the number of the claim from which the claim number highlighted in the Claim Numbering data block depends,
(E.12) highlighting an independent claim in the Claim Numbering data block to display the text of the independent claim in the Claim Number text window,
(E.13) presenting a Change Claim Number option in the Claim Numbering data block,
(E.14)presenting a Change Claim Number data line in response to clicking the Change Claim Number option for inserting a different number to renumber the claim being highlighted in the Claim Number window,
(E.15) changing the claim number highlighted in the Claim Number text window to re-number the claims,
(E.16) presenting a Change Dependency option in the Claim Numbering data block,
(E.17)presenting a Change Parent Claim data line in response to clicking the Change Dependency option for inserting a different number to change the number of the claim being highlighted in the Claim Number text window,
(E.18) changing the claim number highlighted in the Claim Number text window to change the dependency of the claim and to re-number the claims,
(E.19) displaying an Insert option adjacent the Claim Numbering data block for inserting a claim dependent upon a claim number highlighted in the Claim Numbering data block,
(E.20) presenting the display of an Insert Claims data block unless a claim number is highlighted in the Claim Numbering data block,
(E.21) displaying the Insert Claims data block in response to clicking the Insert option,
(E.21.1) presenting a Number of Claims to be Inserted data line in the Insert Claims data block for inserting the number of claims to be inserted,
(E.21.2) inserting the number of claims in the Number of Claims to be Inserted data line in the Insert Claims data block,
(E.21.3) displaying a Insert Claim After Claim data line in the Insert Claims data block for inserting the number of the claim preceding the first claim to be inserted,
(E.21.4) inserting the number of the claim preceding the first inserted claim in the Insert Claim After Claim data line in the Insert Claims data block,
(E.21.5) presenting a Preamble data block displaying the preamble of the first claim to be inserted,
(E.21.6) editing in the Preamble data block to insert the preamble of the first claim to be inserted,
(E.22) presenting a Remove option adjacent the Claim Numbering data block for removing a claim,
(E.23) selecting the Remove option and removing a claim,
(E.24) presenting an Add option adjacent the Claim Numbering data block for adding a claim,
(E.25) selecting the Add option and adding a claim,
(F) selecting Format in the Tool bar to display a Format Document option block,
(F.1) presenting a Show Paragraph Numbers option in the Format Document data block,
(F.2) selecting the Show Paragraph Numbers option for showing the successive numbers of successive paragraphs in brackets at the beginning of each paragraph in the application,
(F.3) presenting a Show Line Numbers option in the Format Document data block to select the option of showing at least some of the line numbers on each page of the application,
(F.4) selecting the Show Line Numbers option for showing at least some of the line numbers on each page of the application,
(F.5) presenting a Justify option in the Format Document data block to select the option of justifying the text on each page of the application,
(F.6) selecting the Justify option in the Format Document data block to justify the text on each page of the application,
(F.7) presenting a Include Line Between Claims option in the Format Document data block to select the option of providing an extra line between claims,
(F.8) selecting the Include Line Between Claims option to provide an extra line between claims,
(F.9) presenting a New Page For Independent Claims option in the Format Document data block to select the option of starting each independent claim at the top of a new page in the application,
(F.10) selecting the New Page For Independent Claims option to start each independent claim at the top of a new page in the application,
(F.11) presenting a Do Not Add Abstract Title option in the Format Document data block to select the option of omitting the title on the Abstract page,
(F.12) selecting the Do Not Add Abstract Title option in the Format Document data block to omit the title on the Abstract page,
(F.13) presenting a Respect Current Fonts option in the Format Document data block to select the option of preserving changes to default fonts,
(F.14) selecting the Respect Current Fonts option to preserve changes to default fonts,
(F.15) presenting a Respect Current Tabs option in the Format Document data block to select the option of preserving changes to default tabs,
(F.16) selecting the Respect Current Tabs option to preserve changes to default tabs,
(G) selecting Build Description in the Tool bar to present a Select Claims data block with the claims listed therein,
(G.1) presenting a Build Text option in response to selecting Build Description,
(G.2) displaying in the Build Text option advice that text already exists in the description section and the YES and NO options to add the new text,
(G.3) selecting the YES option,
(G.4) presenting a Select Claims data block in response to selecting Build Description and one of the Build Text options when Build Text appears,
(G.5) displaying a claim numbers data line with the claim numbers therein in the Select Claims data block,
(G.6) displaying a claim text data line for presenting the text of claims therein in the Select Claims data block,
(G.7) highlighting at least one claim number in the claim numbers data line,
(G.8) displaying the text of the highlighted claim in the claim text data line in response to highlighting the claim in the claim numbers data line,
(G.9) displaying a Use Selected option in the Select Claims data block,
(G.10) displaying a Use All option in the Select Claims data block,
(G.11) selecting the Use Selected option in the Select Claims data block,
(G.12) selecting the Use All option in the Select Claims data block,
(G.13) duplicating the highlighted claims in response to selecting the Use Selected option into a description section of the application without claim numbers and without the word “said” and having paragraph numbers in brackets,
(G.14) duplicating all of the claims in response to selecting the Use All option into a description section of the application without claim numbers and without the word “said” and having paragraph numbers in brackets,
(G.15) presenting the Format Now block with YES and NO options for formatting the document,
(G.16) formatting the document in response to selecting the YES option in the Format Now block,
(H) highlighting an element name in the description section,
(I) selecting Mark Element in the Tool bar to present an Add Element data block with the high-lighted element name presented,
(I.1) presenting options in the Add Element data block to Edit After Creation and to Create Element Combination,
(I.2) selecting Edit After Creation to display an Element data block presenting the element name and synonyms of the element name and an Add option for adding and an Edit option for editing synonyms and a Remove option for removing a synonym and a Lock Element Numeral option to lock the reference numeral to be assigned to the element name to prevent that assigned reference numeral from being changed and an Override Symbol data line for inserting a special reference symbol for the element name and an Element Combinations option,
(I.2.1) selecting the Add option to display an Add Synonym data block for entering additional synonyms for the displayed element name,
(1.2.2) assigning the reference numerals assigned to the element name to all occurrences of that element name and all synonyms added and edited,
(J) selecting Element Combinations in the Tool bar or in any of the Element data blocks to display an Element Combinations data block,
(J.1) presenting an Inferred Combinations data line in the Element Combinations data block to display a selected element name in the plural without an adjective and all reference numerals used with that selected element name differentiated by adjectives,
(J.2) presenting a Disabled Combinations option the in the Element Combinations data block to disable the assignment of any reference numerals to the selected element name in the Inferred Combinations data line so that no reference numeral is assigned to the selected element name when used alone without an adjective and presenting the option to re-enable the assignment of any reference numerals to the selected element name,
(J.3) presenting a User Defined Combinations data line the in the Element Combinations data block to add the selected element name and a new adjective to be numbered with the reference numerals of certain adjectives used with the selected element name,
(K) selecting Number Patent in the Tool bar,
(K.1) displaying a different reference numeral with each root element name with a different adjective to describe different elements in response to highlighting each root element name plus the different adjective for each different adjectively distinguished element in response to selecting Number Patent in the Tool bar,
(K.2) displaying all of the different reference numerals assigned to the root element name differentiated by different adjectives in each instance of the root element name being used without a differentiating adjective in response to selecting Number Patent in the Tool bar,
(K.3) displaying the reference numerals assigned to each element name to all occurrences of that element name and all synonyms added and edited,
(L) selecting Element List in the Tool bar to display an Element List data block to present a list of the element names and the assigned reference numerals along with options to Add and Remove and Edit and to Sort the presented element names alternately alphabetically or in order of reference numeral,
(L.1) selecting the Add option on the Element List data block to present the Add Element data block,
(L.2) adding an element in the Add Element data block,
(L.3) presenting the Element data block in response to adding an element in the Add Element data block and in response to highlighting an element name in the Element List and selecting the Edit option on the Element List data block,
(L.4) highlighting an element name in the Element List and selecting the Remove option on the Element List data block to remove an element name from the Element List,
(L.5) successively selecting the Sort option (38) on the Element List data block to sort the element names on the list alternately in order of reference numeral or alphabetically,
(M) presenting a Number Patent option block presenting the headings of Detailed Description and Abstract and Claims in response to selecting the Number Patent option in the Tool bar,
(M.1) presenting a Show Numbers option under each of the headings of Detailed Description and Abstract and Claims on the Number Patent option block for selecting to show reference numerals therein,
(M.2) inserting the element numerals with each occurrence of the element name in the description section of the application in response to selecting the Show Numbers option under the Detailed Description heading,
(M.3) inserting the element numerals with each occurrence of the element name in the Abstract section of the application in response to selecting the Show Numbers option under the Abstract heading,
(M.4) inserting the element numerals with each occurrence of the element name in the Claims section of the application in response to selecting the Show Numbers option under the Claims heading,
(M.5) presenting a Bold Face option under each of the headings of Detailed Description and Abstract and Claims on the Number Patent option block for selecting to show bold reference numerals therein,
(M.6) inserting the element numerals in a bold font with each occurrence of the element name in the description section of the application in response to selecting the Bold Face option under the Detailed Description heading,
(M.7) inserting the element numerals in a bold font with each occurrence of the element name in the Abstract section of the application in response to selecting the Bold Face option under the Abstract heading,
(M.8) inserting the element numerals in a bold font with each occurrence of the element name in the Claims section of the application in response to selecting the Bold Face option under the Claims heading,
(M.9) presenting a Include Parenthesis option under each of the headings of Detailed Description and Abstract and Claims on the Number Patent option block for selecting to show reference numerals in parenthesis therein,
(M.10) inserting the element numerals between parenthesis in each occurrence of the element name in the description section of the application in response to selecting the Include Parenthesis option under the Detailed Description heading,
(M.11) inserting the element numerals between parenthesis in each occurrence of the element name in the Abstract section of the application in response to selecting the Include Parenthesis option under the Abstract heading,
(M.12) inserting the element numerals between parenthesis in each occurrence of the element name in the Claims section of the application in response to selecting the Include Parenthesis option under the Claims heading,
(M.13) presenting a Building Element List option on the Number Patent option block for electing to generate an element list,
(M.14) generating the element list in response to selecting the Building Element List option,
(M.15) presenting a Report Element Problems option on the Number Patent option block for electing to generate an Element Report data block in response to inconsistencies in the element list,
(M.16) generating an Element Report data block response to inconsistencies in the element list in response to selecting the Report Element Problems option,
(M.17) presenting a Reorder Numbers option on the Number Patent option block for electing to assign reference numerals to elements in the order of being first recited in the description section of the application so that the elements are numbered in order of first recitation in the description section of the application,
(M.18) presenting a Starting Number data line on the Number Patent option block for selecting the lowest reference numeral to be used in numbering the elements in the application and presenting a default starting reference numeral,
(M. 19) replacing the default reference numeral in the Starting Number data line on the Number Patent option block with the lowest reference numeral to be used in numbering the elements in the application,
(M.20) presenting an Increment data line on the Number Patent option block for selecting the number of numerals to be omitted between reference numerals to be used in numbering the elements in the application,
(M.21) inserting the number of numerals to be omitted between reference numerals in the Increment data line,
(M.22) assigning the reference numerals with element names and synonyms in the order of being first recited in the description section of the application and starting with the lowest reference numeral in the Starting Number data line and separated by the number of numerals to be omitted in the Increment data line,
(M.23) presenting an OK option on the Number Patent option block,
(N) displaying the reference numerals with element names and synonyms in the application in response to selecting the Number Patent option in the Tool bar and/or selecting OK in anyone of the Number Patent option block and the Add Element and Edit After Creation and Create Element Combination data blocks,
(O) selecting Protect in the Tool bar to display a Protect Numbers data block presenting a Protect Selected Text Numbers option and an Auto Protect option,
(O.1) highlighting a number in the application to be protected against change,
(O.2) selecting the Protect Selected Text Numbers option to add the numbers to be protected and assigning a sequential digit in the Protect Numbers data block,
(O.3) selecting the Auto-Protect option to present an AutoProtect Numbers data block presenting a This Document heading and an All Document heading with a before data line and an after data line associated with each heading and presenting an Add option and a Remove option adjacent each before and after data line and an OK option,
(O.3.1) presenting an AutoProtect data line for inserting a word so that all numbers before the word will be automatically protected from change during patent numbering routines in response to clicking the Add option associated with either of the before data lines of either of the Document headings,
(O.3.2) inserting a word in the AutoProtect data line to protect numbers before the word,
(O.3.3) presenting an AutoProtect data line for inserting a word so that all numbers after the word will be automatically protected from change during patent numbering routines in response to clicking the Add option associated with either of the after data lines of either of the Document headings,
(O.3.4) inserting a word in the AutoProtect data line to protect all numbers after the word,
(O.3.5) protecting against change all numbers before and after the words inserted in anyone of the AutoProtect data lines during patent numbering routines in response to selecting the OK option presented by the AutoProtect Numbers data block,
(O.3.6) removing a word from a data line in response to highlighting the word and clicking on the Remove option associated with anyone of the data lines of the Document headings in the AutoProtect Numbers data block,
(P) selecting the Build Intro Sections option in the Tool bar,
(P.1) presenting the Select Claims data block in response to selecting Build Intro Sections option in the Tool bar to present a claim to be used as an intro claim in building the introductory sections of the application,
(P.2) duplicating the characterized by portion of the intro claim into a Summary of Invention section of the application without a claim number and without the word “said” and without reference numerals in response to executing the Select Claims data block,
(P.3) duplicating that portion of the intro claim preceding the characterized by clause into a Background section of the application without the claim number and without the word “said” and without reference numerals in response to executing the Select Claims data block,
(P.4) duplicating the preamble of the intro claim into a Technical Field section of the application without a claim number and without the word “said” and without reference numerals in response to executing the Select Claims data block,
(P.5) displaying a cross reference heading to another application as the first heading in the application in response to executing the Select Claims data block,
(P.6) editing the introductory sections of the application,
(Q) creating an Abstract page in response to selecting the Build Abstract option in the Tool bar,
(R) automatically changing the paragraph numbers in brackets in response to adding a paragraph to the application,
(S) selecting the Count Abstract option in the Tool bar, and
(T) counting and presenting the number of words absent reference numerals in the Abstract section in response to selecting the Count Abstract option.

2. A method of preparing a patent application comprising the steps of;
numbering and rearranging the order of claims and duplicating claims into the specification and assigning reference numerals to elements,
running a software macro to present a Tool bar in a word processing program,
presenting options in the Tool bar on a display screen of Setup and Number Claims and Build Description and Build Intro Sections and Build Abstract and Count Abstract and Format and Mark Element and Element List and Number Patent,
selecting Number Claims in the Tool bar to present a Claim Numbering data block with the claim numbers therein and presenting a Collect option adjacent the Claim Numbering data block for arranging the order of and renumbering the claims to place each claim as close as possible to the parent claim from which it depends and a Claim Number text window adjacent the Claim Numbering data block for displaying the text of a claim number highlighted in the Claim Numbering data block,
highlighting an element name in the description section, selecting Mark Element in the Tool bar to present an Add Element data block with the high-lighted element name presented,
presenting options in the Add Element data block to Edit After Creation and to create Element Combinations,
electing Edit After Creation to display an Element data block presenting the element name and synonyms of the element name and an Add option for adding and an Edit option for editing synonyms and a Remove option for removing a synonym,
selecting the Add option to display an Add Synonym data block for entering additional synonyms for the displayed element name, and
assigning the reference numerals assigned to the element name to all occurrences of that element name and all synonyms added and edited.
